(19) United States
(12) Patent Application Publication
(10) Pub. No.: US 2002/0092208 A1
(43) Pub. Date: Jul. 18, 2002

(54) Spot mounder

(76) Inventor: David W. Heckendorf, Queensland (AU)

Correspondence Address: QUARLES & BRADY LLP, 411 E. WISCONSIN AVENUE, SUITE 2040, MILWAUKEE, WI, 53202-4497, US

(21) Appl. No.: 09/776,213

(22) Filed: Feb. 2, 2001

(30) Foreign Application Priority Data
Jan. 12, 2001 (AU) 13684/01

(51) Int. Cl. A01B 5/00

(52) U.S. Cl. 37/403

(57) ABSTRACT

A spot mounder with an excavator mount by which the mounder can be supported which includes two concave discs with adjustable orientation and includes rearwardly extending tynes which can be swung around to be used to clear a site prior to any mound formation action.

This invention relates to both a method and apparatus for spot mounding.

The technique of spot mounding is used to prepare soil for planting of a plant such as a tree.

One problem to which this invention is generally directed is to provide a method of spot mounding in the one case or an apparatus for spot mounding in another whereby spot mounding can be achieved economically.

In one form of this invention there is proposed a spot mounder having an excavator mount by which it can be supported, and having two concave discs supported to be oppositely facing to define therebetween a mounding formation area.

In preference, the spot mounder is supported through its excavator mount to an excavator arm so that it can be variously positioned so as to assume at least in one case, a mounding position, and then be drawn through the soil with respective concave discs effecting a shifting of the soil into the mounding formation area between the discs to leave thereby a spot mound.

In preference, the spot mounder includes a rake supported and arranged so that it can be brought into an operating position by altering orientation of the mounder.

In preference, the rake is arranged so that by changing the support orientation of the mounder, the mounder is changeable in position between a raking operable position and a mounding operable position.

In preference, each of the concave discs is supported so that at least one of the discs can be changed in its orientation position relative to the other.

In preference, each disc is aligned when in a facing direction with respect to its oppositely positioned other disc, within a range of from 21 degrees to 26 degrees with respect to a forward to rearward alignment.

In preference, each of the discs is able to be positioned within a selected alignment relative to a supporting body of the mounder.

In another form, the invention, although this need not necessarily be the only or indeed the broadest form of this can reside in a spot mounder including a body, two concave discs each supported by the body by a rotatable support with respect to the body so that each disc is rotatable about an axis extending orthogonally through a center of a substantially circular perimeter of the respective disc, each disc being positioned with a concave side of each of the discs facing a mounding formation area which is located between the discs, and an excavator mount support secured to the body.

In preference, the said discs are supported to be aligned so that each respective concave side is facing a direction which is inclined to a mounding direction.

In preference, each of the discs is supported by an axle so as to be rotatable about its circular axis.

In preference, the spot mounder further includes a centrally positioned tyne adapted to effect a digging of soil when the spot mounder is in a mounding position.

In preference, there are raking members extending rearwardly from the mounder body such as to be able to be bought into a raking operable position.

In preference, the raking members include a plurality of raking fingers which are aligned but spaced apart so as to be able to effect a raking action when positioned in an appropriate way.

In a further form of this invention, although this need not necessarily be the only or indeed the broadest form, there is proposed a method of mounding which includes the step of attaching a spot mounder as has been described in any one of the preceding references lo one or more features thus described in those references, to the outer end of an excavator arm assembly, and then effecting control of the excavator arm assembly to effect a shifting of the spot mounder through the ground in a mounding operable position to effect a mounding action.

In preference, each of the concave discs includes a peripheral cutting edge which also includes a plurality of spaced apart scallop shapes.

When reference is made to an orientation of a concave disc, the orientation is first established by reference to a plane defined by a circle touching the outermost periphery apart from any scallop shape of a respective disc.

In preference, the orientation of a disc can be changed by supporting the disc by means of an axial support so that the disc itself can rotate about a central axis passing orthogonally through the plane defined by the stated peripheral circle, and the orientation is then further adjustable by reason that the bearing thus supporting the respective concave disc is supported itself by a shaft which is upwardly extending so that rotation of such an axel will have the inclination angle or orientation of a respective disc changed and this at least through the range of from 21 to 26 degrees with respect to a forward to rearward alignment.

One of the advantages of the arrangement described is that an excavator is a very commonly available device and economically accessible.

An excavator arm is arranged to be widely controllable and manipulateable from a control centre and by providing a tool such as that described, namely the spot mounder as described, the mechanism of an excavator can be very easily adapted and used to effect rapidly and economically spot mounding.

Further, because the head of an excavator arm can be rotatably adjustably controllable, a spot mounder having raking members or fingers that can be bought into a raking position, can be quickly used to effect removal of surface debris, such as previously felled branches, logs, grass or stones, and thereafter, the discs and if chosen, a deep digging tyne can be brought into an operable position and by a single drawing in of the spot mounder at the end of the excavator arm, a spot mounding can be effected in the soil with the one stroke.

Accordingly, it will be seen that with an outward stroke with the spot mounder having the rake in the operable position, the site can be cleared, a rotation of the head to bring the discs into position is then quickly possible and when the discs are then lowered into the ground, a drawing in of the disc will quickly and efficiently then effect the spot mounding.

In other words, operation of this device using an excavator can be very simple indeed so that an operator can “crowd” his bucket controls which, of course, are in relation now to the spot mounder, to make the rake substantially vertical to the ground, the boom or excavator arm can then be lowered and the debris can then be swept away from the spot to be mounded.

In an actual example, this system will provide ripping and mounding over a distance of one and a half to two meters and can put a small mound over a rip line with opposing 32 inch discs.

On light, sandy soils, the deep tyne or ripper shank can be removed entirely as compared to its use where heavier clay soils are used.

For a better understanding of this invention it will now be described with reference to a preferred embodiment which shall be described with the assistance of drawings wherein:

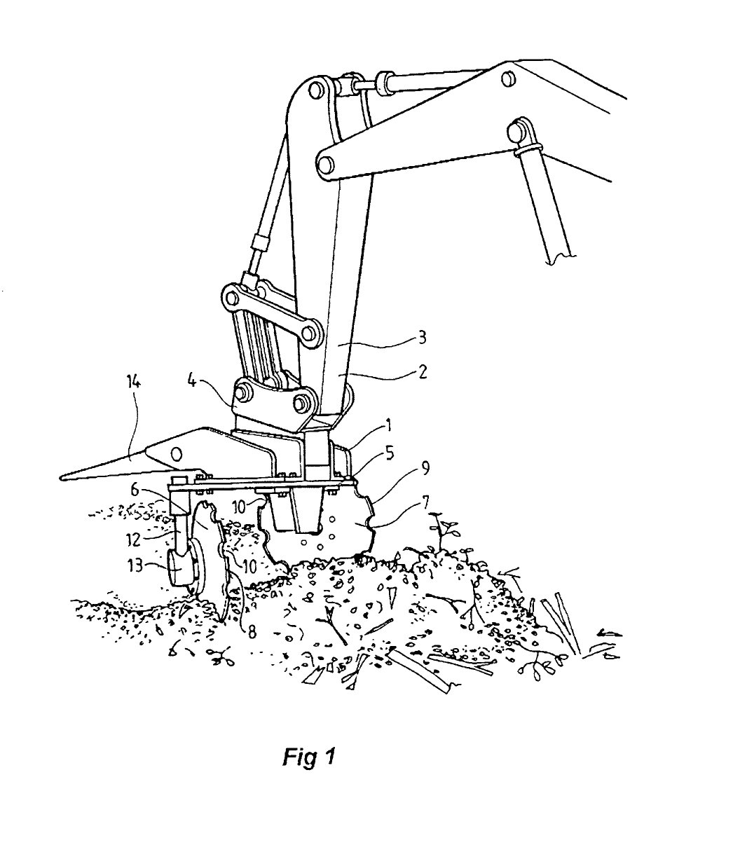

FIG. 1 is a perspective view of a spot mounder according to the first embodiment, positioned in a mounding operable position and supported at the end of an excavator arm assembly;

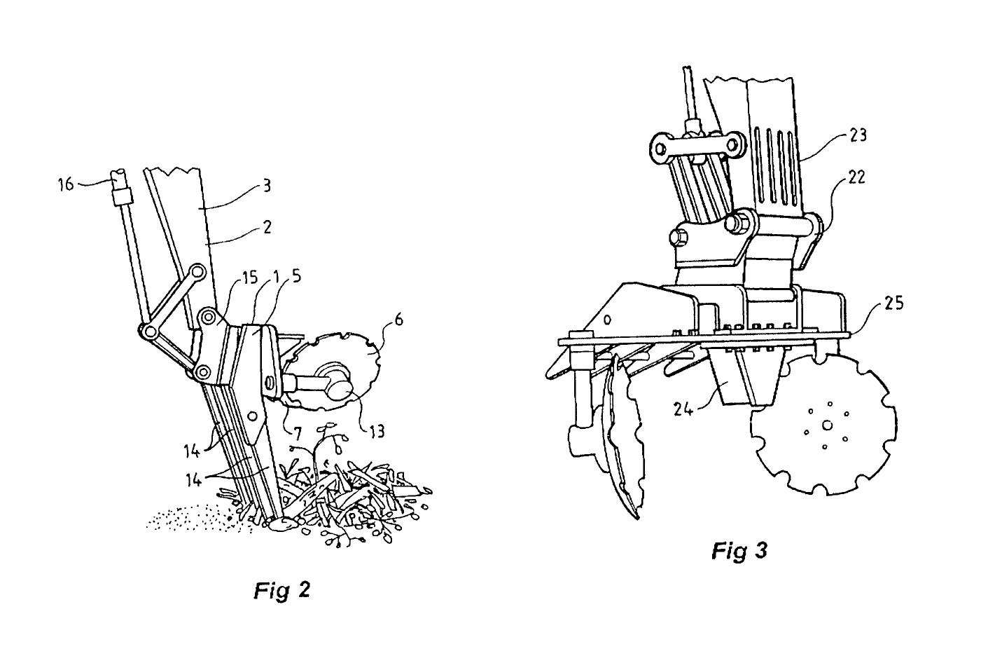

FIG. 2 is a perspective view of the same embodiment as shown in FIG. 1 in which the spot mounder is now altered in position to be in a raking operable position;

FIG. 3 is a perspective view of a second embodiment where the spot mounder is now in the spot mounding operable position and there is included means to support a deep ripping tyne; and

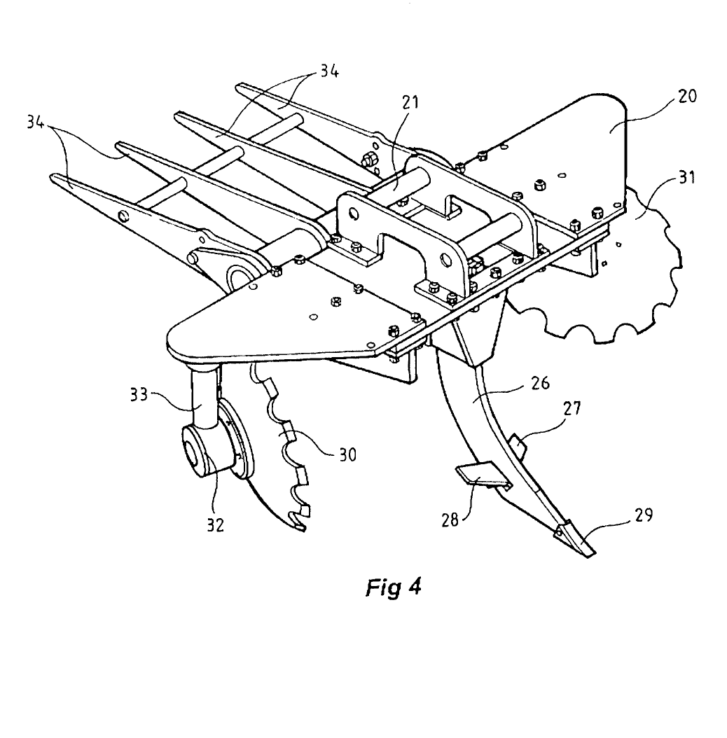

FIG. 4 is a perspective view of the spot mounder shown in FIG. 3 with a deep tyne in position with the spot mounder separated from support of the excavator arm.

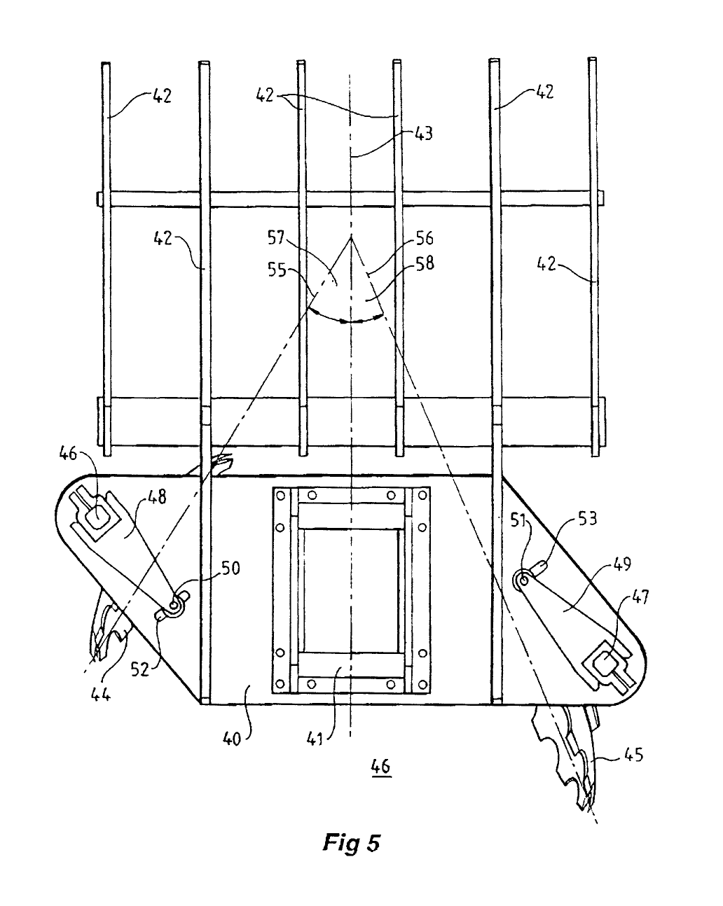

FIG. 5 is a plan view of a further embodiment which shows in particular an excavate amount and also an orientation control arrangement for each of two concave discs.

Now referring to the drawings in detail and in particular to FIGS. 1 and 2, there is shown a spot mounder 1 which is attached to an excavator 2 which has an excavator arm assembly 3, a lower end of which at 4 is attached by suitable and conventional attachment means to the spot mounder 1.

The spot mounder 1 includes a body 5 to which there are firstly secured and supported two concave discs 6 and 7, these being supported so as to be rotatable about their own axes which is defined by, in each case, the peripheries such as at 8 in the one case and 9 in the other, disregarding the scallops such as at 10 and 11.

The result of this is that we have two concave discs which are supported so as to be relatively inclined with respect to a forward to aft direction of the mounder, the concave sides respectively facing each other to a selected extent and being set at the selected angle by reason of selected orientation about an support at 12 in the one case and an equivalent support not shown in the other case.

There is the forward to aft alignment which is established by the body 5 which is that direction which the body will be moved in without any pivoting rotation of the excavator arm assembly 3 and which is substantially established by the excavator mount.

Such a forward to rearward alignment is useful to establish the relative alignment of the respective concave discs 6 and 7 and, in this case, each of them is chosen to be inclined with respect to the forward to rearward alignment at twenty five degrees which is to say the angle of a plane defined by the periphery of a disk is aligned to have an included angle of 25 degrees with respect to the forward to aft alignment.

This can be varied at least between twenty degrees and thirty degrees in each case for optimum effect in soil conditions which can be established in each case by experimentation.

The discs in each case being serrated concave discs in this case are thirty two inch in diameter and are supported by appropriate bearings such as at 13 shown on one side.

Extending rearwardly when in the position as shown in FIG. 1, there are a plurality of tynes 14 which are aligned so as to be parallel, one with respect to the other, and extending generally rearwardly and at approximately right angles to a vertical position of the support 12.

Accordingly, using the appropriate controls to adjust the head 15 of the excavator support assembly 3, such as, for instance, hydraulic ram 16, allows the mounder 1 to be upturned and to be brought into the raking operable position as shown in FIG. 2.

The method is to bring the mounder 1 into this position and use this to push debris from the ground away from the area to be dug and mounded.

As can now be seen, the spot mounder 1 as supported by an excavator assembly, allows for very quick spot mounding by three sequential movements controlled by an operator, which is to first have the rake in the position as shown in FIG. 2, use this to scrape across the ground to be mounded, and then simply turn the head 15 around to horizontal and then bring the discs back so as to cut into the soil and cut this and push this into a central spot mound area.

The value, of course, is that this can be done very quickly and effectively in many situations using simply the very commonly available system of conventional excavators.

If we now look at the further embodiment shown in FIG. 3, and in the case of FIG. 4 with the attached tyne, there is shown an assembly on the top of the mounder 20 at 21 to enable an appropriate attachment to be made to the head 22 of the excavator support assembly 23 (which also defines a forward to aft alignment).

A socket 24 is attached to the underneath side of the body 25 to which the tyne 26 can be adjustably positioned where the tyne is a deep cutting tyne with blades 27 and 28 and a deep cutting replaceable tip at 29.

The position of the tyne 26 is midway between the discs 30 and 31 which are again concave discs with outer scalloped edges and these are supported by bearing 32 and shaft 33 in the one case and the equivalent on the other side which is not specifically shown.

The angle of inclination so as to effect a slight inclination and opposing orientation of the respective concave discs 30 and 31 is supported so as to again have these at the angle of twenty five degrees to a forward to aft direction and furthermore there are rearwardly depending fingers at 34 which can be brought into position by the simple implementation of turning the head 22 through the method of spot mounding.

Using a deep ripper tyne such as the tyne 26 is appropriate in heavier clay soils where more soil fracture is required and a deeper cut.

Experiments so far have suggested ripper depths of approximately from 400 to 600 millimeters are appropriate but these can be adjusted as required.

In the further embodiment described in FIG. 5, there is a body 40 which includes an excavator mount 41 located centrally within the body and projecting rearwardly in the arrangement and orientation shown in the figure, a plurality of times at 42.

A forward to aft alignment is shown by axis 43 which in this case is parallel to the times 42 and passes through the centre of the body 40 of the spot mounder.

Located at each side of the body 40 is a concave disc shown in the one case at 44 and in the other at 45.

Each of the concave discs is positioned so that a concave side is inwardly facing so as to be directed gene rally toward a mounding area which is shown broadly at 46.

Further, each of the concave discs 44 and 45 are supported so as to be rotatable at about an approximately horizontal axis when being used in the position as shown in FIG. 5 on the basis that the planned view is in a vertical position directly above the spot mounder.

However, the alignment of each respective concave disc 44 and 45 is able to be varied by rotation about a vertical axis when in the position as shown in FIG. 5 and this is achieved by having a spindle 46 in the one case and 47 in the other which is rotatably supported by being secured to the body 40.

An arm 48 in one case and 49 in the other is locked onto the respective spindle 46 and 47 and the orientation of the spindle 46 and 47 is controlled by the position of the arm 48 and 49 which in turn is held in position by a bolt such as 50 in the one case and 51 in the other passing through a slot shown at 52 in one case and 53 in the other.

In this way, the orientation of the alignment of the respective concave disc 44 can be controlled and in this case this alignment is shown generally by access 55 in one case and 56 in the other and it is the alignment of these respective axes with the forward to aft alignment 43 which defines the relative orientation angle which is shown at 57 in one case and 58 in the other.

It is this general angle that can be changed to make the relationship between the concave discs 44 and 45 varied but as has been previously stated, 25 degrees has been considered a best angle for trials thus far conducted.

Now what has been described and explained can be seen to be a very valuable concept in relation to spot mounding which allows for both economic and quick mounding effects to be achieved.

The claims defining the invention are as follows:

1. A spot mounder having a body with an excavator mount by which the mounder can be supported, and having two concave discs supported to be respectively oppositely facing with the respective concave sides to define therebetween a mounding formation area.

2. A spot mounder including a body, two concave discs each supported by the body by a rotatable support with respect to the body so that each disc is rotatable about an axis extending orthogonally through a center of a substantially circular perimeter of the respective disc, each disc being positioned with a concave side of each of the discs facing a mounding formation area which is located between the discs, and an excavator mount support secured to the body.

3. A spot mounder as in either one of preceding claim 1 or 2 further characterised in that a rake is supported by the body and arranged so that it can be changed from a storage position into an operating position by altering orientation of the body.

4. A spot mounder as in preceding claim 3 further characterised in that the rake is supported by the body so that, by changing the support orientation of the body, the mounder while being supported by an excavator arm is changeable in position between a raking operable position and a mounding operable position.

5. A spot mounder as in any one of the preceding claims further characterised in that each of the concave discs is supported so that at least one of the discs can be changed in its orientation position about a substantially vertical axis when in a supported mounding operable position relative to the other.

6. A spot mounder as in preceding claim 5 further characterised in that each disc is aligned when in a facing direction with respect to its oppositely positioned other disc, within a range of from 21 degrees to 26 degrees about a vertical axis with respect to a forward to rearward alignment of a mounding formation action.

7. A spot mounder having an excavator mount connector arrangement, and mounding means which are characterised by including at least two concave discs supported and aligned so that they can be drawn through the ground by an excavator, when the mounder is attached thereto, and effect thereby a cutting into and causing a mounding of soil from each of two sides by the respective discs into a middle mounding area.

8. A spot mounder as in claim 7 further characterised in that the said discs are aligned so that each respective concave side is facing a direction, which is inclined to a mounding direction.

9. A spot mounder as in claim 7 further characterised in that each of the discs is supported by an axle so as to be rotatable about its circular axis.

10. A spot mounder as in claim 7 further characterised in that the spot mounder further includes a centrally positioned tyne adapted to effect a digging of soil when the spot mounder is in a mounding position and being moved through the soil to effect a mounding.

11. A spot mounder as in claim 3 further characterised in that the rake has a plurality of raking fingers which are aligned one with respect to the other but spaced apart so as to be able to effect a raking action.

12. A spot mounder as in claim 2 further characterised in that the orientation of a disc can be changed by supporting the disc by means of an axial support so that the disc itself can rotate about a central axis passing orthogonally through the plane defined by the stated peripheral circle, and the orientation is then further adjustable by reason that the bearing thus supporting the respective concave disc is supported itself by a shaft which is upwardly extending so that rotation of such an axle will have the inclination angle or orientation of a respective disc changed and this at least through the range of from 21 to 26 degrees with respect to a forward to rearward alignment.

13. A spot mounder as in any one of the preceding claims when attached to an excavator, which has an excavator arm assembly, a lower end of which is attached to the spot mounder.

14. A spot mounder as in any one of the preceding claims where each of the concave discs are supported so as to be rotatable about their own axes which is defined by, in each case, a circular periphery of a respective disc and which are supported so as to be relatively inclined with respect to a forward to aft direction of the mounder, the concave sides respectively facing each other to a selected extent and being set at a selected angle by reason of selected orientation about a support.

15. A spot mounder as in claim 8 further characterised in that the spot mounder further includes a centrally positioned tyne adapted to effect a digging of soil when the spot mounder is in a mounding position.

16. A spot mounder as in any one of the preceding claims further characterised in that there is a rake with raking members extending rearwardly from the mounder body such as to be able to be bought into a raking operable position.

17. A spot mounder as in any one of the preceding claims further characterised in that the orientation of a disc can be changed by supporting the disc by means of an axial support so that the disc itself can rotate about a central axis passing orthogonally through the plane defined by the stated peripheral circle. and the orientation is then further adjustable by reason that the bearing thus supporting the respective concave disc is supported itself by a shaft which is upwardly extending so that rotation of such an axel will have the inclination angle or orientation of a respective disc changed and this at least through the range of from 21 to 26 degrees with respect to a forward to rearward alignment.

18. A method of mounding which includes the step of attaching a spot mounder as has been described in any one of the preceding claims to an outer end of an excavator arm assembly, and then effecting control of the excavator arm assembly to effect a shifting of the spot mounder through the ground in a mounding operable position to effect a spot mounding action.

19. A method of spot mounding as in the immediately preceding claim further characterised in that each of the concave discs includes a peripheral cutting edge which also includes a plurality of spaced apart scallop shapes.

20. A method of spot mounding characterised in that the spot mounder includes a rake supported and arranged so that it can be brought into an operating position by altering orientation of the spot mounder.

21. A spot mounder substantially as described in the specification with reference to and as illustrated by the accompanying drawings.

22. A method of mounding substantially as described in the specification with reference to and as illustrated by the accompany drawings.
